(19) United States
(12) Patent Application Publication
(10) Pub. No.: US 2022/0091269 A1
(43) Pub. Date: Mar. 24, 2022

(54) Depth mapping using spatially-varying modulated illumination

(71) Applicant: APPLE INC., Cupertino, CA (US)

(72) Inventors: Bernhard Buettgen, San Jose, CA (US); Gregory A. Cohoon, Sunnyvale, CA (US); Tomas G. Van den Hauwe, Santa Clara, CA (US)

(21) Appl. No.: 17/464,698

(22) Filed: Sep. 2, 2021

Related U.S. Application Data
(60) Provisional application No. 63/080,811, filed on Sep. 21, 2020.

(51) Int. Cl. G01S 17/894; G01S 17/32; G01S 17/10; G01S 7/48

(52) U.S. Cl. CPC G01S 17/894; G01S 7/4804; G01S 17/10; G01S 17/32

(57) ABSTRACT

Apparatus for optical sensing includes an illumination assembly, which directs a first array of beams of optical radiation toward different, respective areas in a target scene while temporally modulating the beams with a carrier wave having a carrier frequency. A detection assembly receives the optical radiation that is reflected from the target scene, and includes a second array of sensing elements, which output respective signals in response to the optical radiation that is incident on the sensing elements during one or more detection intervals, which are synchronized with the carrier frequency, and objective optics, which form an image of the target scene on the second array. Processing circuitry drives the illumination assembly to apply a spatial modulation pattern to the first array of beams and processes the signals output by the sensing elements responsively to the spatial modulation pattern in order to generate a depth map of the target scene.

### CROSS-REFERENCE TO RELATED APPLICATION

This application claims the benefit of U.S. Provisional Patent Application 63/080,811, filed Sep. 21, 2020, which is incorporated herein by reference.

### FIELD OF THE INVENTION

The present invention relates generally to depth mapping, and particularly to methods and apparatus for depth mapping using indirect time of flight techniques.

### BACKGROUND

Various methods are known in the art for optical depth mapping, i.e., generating a three-dimensional (3D) profile of the surface of an object by processing an optical image of the object. This sort of 3D profile is also referred to as a 3D map, depth map or depth image, and depth mapping is also referred to as 3D mapping. In the context of the present description and in the claims, the terms “optical radiation” and “light” are used interchangeably to refer to electromagnetic radiation in any of the visible, infrared, and ultraviolet ranges of the spectrum.

Some depth mapping systems operate by measuring the time of flight (TOF) of radiation to and from points in a target scene. In direct TOF (dTOF) systems, a light transmitter, such as a laser or array of lasers, directs short pulses of light toward the scene. A receiver, such as a sensitive, high-speed photodiode (for example, an avalanche photodiode) or an array of such photodiodes, receives the light returned from the scene. Processing circuitry measures the time delay between the transmitted and received light pulses at each point in the scene, which is indicative of the distance traveled by the light beam, and hence of the depth of the object at the point, and uses the depth data thus extracted in producing a 3D map of the scene.

Indirect TOF (iTOF) systems, on the other hand, operate by modulating the amplitude of an outgoing beam of radiation at a certain carrier frequency, and then measuring the phase shift of that carrier wave in the radiation that is reflected back from the target scene. The phase shift can be measured by imaging the scene onto an optical sensor array, and acquiring demodulation phase bins in synchronization with the modulation of the outgoing beam. The phase shift of the reflected radiation received from each point in the scene is indicative of the distance traveled by the radiation to and from that point, although the measurement may be ambiguous due to range-folding of the phase of the carrier wave over distance.

### SUMMARY

Embodiments of the present invention that are described hereinbelow provide improved apparatus and methods for depth measurement and mapping.

There is therefore provided, in accordance with an embodiment of the invention, apparatus for optical sensing, including an illumination assembly, which is configured to direct a first array of beams of optical radiation toward different, respective areas in a target scene while temporally modulating the beams with a carrier wave having a carrier frequency. A detection assembly is configured to receive the optical radiation that is reflected from the target scene. The detection assembly includes a second array of sensing elements, which are configured to output respective signals in response to the optical radiation that is incident on the sensing elements during one or more detection intervals, which are synchronized with the carrier frequency, and objective optics, which are configured to form an image of the target scene on the second array. Processing circuitry is configured to drive the illumination assembly to apply a spatial modulation pattern to the first array of beams and to process the signals output by the sensing elements responsively to the spatial modulation pattern in order to generate a depth map of the target scene.

In some embodiments, the processing circuitry is configured to use the spatial modulation pattern in estimating a contribution of multipath interference to the signals, and to subtract out the contribution in computing depth coordinates of points in the target scene. In a disclosed embodiment, the processing circuitry is configured to receive, with respect to each of the points, first and second signals output by the array of sensing elements in response, respectively, to first and second phases of the spatial modulation pattern, to compute first and second phasors based on a relation of the first and second signals, respectively, to the carrier wave, and to compute a difference between the first and second phasors in order to subtract out the contribution of the multipath interference.

In one embodiment, the processing circuitry is configured to derive the first and second signals from different, respective first and second sensing elements in the vicinity of each of the points, wherein different, respective phases of the spatial modulation pattern on the target scene are imaged onto the first and second sensing elements.

In another embodiment, the processing circuitry is configured to derive the first and second signals from a respective sensing element in the vicinity of each of the points, due to different, first and second phases of the spatial modulation pattern on the target scene that are imaged onto the respective sensing element during respective first and second periods of operation of the illumination assembly.

Additionally or alternatively, the spatial modulation pattern defines a binary amplitude variation such that during at least some periods of operation of the illumination assembly, first areas of the target scene are illuminated by the temporally-modulated beams, while second areas of the target scene, interleaved between the first areas, are not illuminated by the temporally-modulated beams. In a disclosed embodiment, the processing circuitry is configured to drive the illumination assembly so that the first areas of the target scene are illuminated by the temporally-modulated beams while the second areas of the target scene are not illuminated by the temporally-modulated beams during first periods of the operation, and the second areas of the target scene are illuminated by the temporally-modulated beams while the first areas of the target scene are not illuminated by the temporally-modulated beams during second periods of the operation.

Alternatively, the spatial modulation pattern defines a spatial variation of the carrier wave, such that first beams illuminating respective first areas of the target scene are modulated at a first carrier frequency, while second beams illuminating respective second areas of the target scene are modulated at a second carrier frequency, different from the first carrier frequency. In a disclosed embodiment, the second carrier frequency is twice the first carrier frequency, and the detection intervals of the sensing elements have a sampling frequency that is equal to the first carrier frequency and a duty cycle that is not equal to 50%.

In one embodiment, the spatial modulation pattern defines multiple parallel stripes extending across the target scene, including at least a first set of the stripes and a second set of the stripes interleaved in alternation with the first set, having different, respective first and second modulation characteristics.

In another embodiment, the spatial modulation pattern defines a grid including at least first and second interleaved sets of areas, having different, respective first and second modulation characteristics.

There is also provided, in accordance with an embodiment of the invention, a method for optical sensing, which includes directing a first array of beams of optical radiation toward different, respective areas in a target scene while temporally modulating the beams with a carrier wave having a carrier frequency. An image of the target scene is formed on a second array of sensing elements, which output respective signals in response to the optical radiation that is reflected from the target scene and is incident on the sensing elements during one or more detection intervals, which are synchronized with the carrier frequency. The illumination assembly is driven to apply a spatial modulation pattern to the first array of beams, and the signals output by the sensing elements are processed responsively to the spatial modulation pattern in order to generate a depth map of the target scene.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a depth mapping apparatus, in accordance with an embodiment of the invention;

FIG. 2 is schematic representation of a spatial modulation pattern used in a depth mapping apparatus, in accordance with alternative embodiments of the invention;

FIG. 3 is a block diagram that schematically shows details of sensing and processing circuits in a depth mapping apparatus, in accordance with an embodiment of the invention;

FIGS. 4A, 4B and 4C are phasor diagrams that schematically illustrate a process of canceling multipath interference in a depth calculation, in accordance with an embodiment of the invention;

FIGS. 5, 6, 7 and 8 are schematic timing diagrams illustrating schemes for capture and readout of iTOF data, in accordance with embodiments of the invention; and

FIG. 9 is a plot that schematically illustrates a method for capture and readout of multi-frequency iTOF data, in accordance with an embodiment of the invention.

### DETAILED DESCRIPTION OF EMBODIMENTS

### Overview

Optical indirect TOF (iTOF) systems that are known in the art illuminate a target scene with light that is temporally modulated with a certain carrier wave, and then use multiple different acquisition phases in the receiver in order to measure the phase shift of the carrier wave in the light that is reflected from each point in the target scene. The phase shift at each point is proportional to the depth, i.e., the distance of the point from the iTOF camera. To make these phase shift measurements, many iTOF systems use special-purpose image sensing arrays, in which each sensing element is designed to demodulate the transmitted modulation signal individually to receive and integrate light during a respective phase of the cycle of the carrier wave. At least three different demodulation phases are needed in order to measure the phase shift of the carrier wave in the received light relative to the transmitted beam. For practical reasons, most systems acquire light during four or more distinct demodulation phases.

In a typical image sensing array of this sort, the sensing elements are arranged in clusters of four sensing elements (also referred to as “pixels”), in which each sensing element accumulates received light over at least one phase of the modulation signal, and commonly over two phases that are 80 degrees apart. The phases of the sensing elements are shifted relative to the carrier frequency, for example at 0°, 90°, 180° and 270°. A processing circuit combines the respective signals from the four pixels (referred to as I₀, I₉₀, I₁₈₀ and I₂₇₀, respectively) to extract a depth value, which is proportional to the function tan⁻¹[(I₂₇₀−I₉₀)/(I₀−I₁₈₀)]. The constant of proportionality and maximal depth range depend on the choice of carrier wave frequency. The formula for converting pixel signals to depth values can be adapted, mutatis mutandis, for other choices of sensing phases, such as 0°, 120° and 240°.

Other iTOF systems use smaller clusters of sensing elements, for example pairs of sensing elements that acquire received light in phases 180° apart, or even arrays of sensing elements that all share the same detection interval. In such cases, the synchronization of the detection intervals of the entire array of sensing elements is shifted relative to the carrier wave of the transmitted beam over successive acquisition frames in order to acquire sufficient information to measure the phase shift of the carrier wave in the received light relative to the transmitted beam. The processing circuit then combines the pixel values over multiple successive image frames in order to compute the depth coordinate for each point in the scene.

In addition to light that is directed to and reflected back from points in the target scene, the sensing elements in an iTOF system may receive stray reflections of the transmitted light, such as light that has reflected onto a point in the target scene from another nearby surface. When the light received by a given sensing element in the iTOF sensing array includes stray reflections of this sort, the difference in the optical path length of these reflections relative to direct reflections from the target scene can cause a phase error in the measurement made by that sensing element. This phase error will lead to errors in computing the depth coordinates of points in the scene. The effect of these stray reflections is referred to as “multi-path interference” (MPI). There is a need for means and methods that can recognize and mitigate the effects of MPI in order to minimize artifacts in iTOF-based depth measurement and mapping.

Embodiments of the present invention that are described herein address the problem of MPI in iTOF signals using spatial modulation of the temporally-modulated pattern of optical radiation that illuminates the target scene. In some embodiments, the spatial modulation is binary, meaning that the temporally-modulated light is turned on in some regions of the scene and off in other, neighboring regions, for example in a pattern of alternating stripes. Alternatively or additionally, the frequency of the carrier wave may be spatially modulated in a similar sort of pattern. In either case, the differences in the signals output by the sensing elements due to the spatial modulation of the optical radiation are applied in calculating and then subtracting out the contribution of multipath interference (MPI), and thus computing depth coordinates with greater accuracy.

In some embodiments, the spatial modulation pattern defines multiple parallel stripes extending across the target scene. At least a first set of the stripes is interleaved in alternation with a second set of the stripes, with the stripes in each set having different, respective modulation characteristics. Alternatively, other patterns may be used. For example, the spatial modulation pattern may define a grid including at least first and second interleaved sets of areas, having different, respective first and second modulation characteristics.

The disclosed embodiments thus provide apparatus for optical sensing in which an illumination assembly directs an array of beams of optical radiation toward different, respective areas in a target scene while temporally modulating the beams with a carrier wave. A detection assembly receives and senses the optical radiation that is reflected from the target scene. Specifically, objective optics in the detection assembly form an image of the target scene on an array of sensing elements, which output respective signals in response to the optical radiation that is incident on the sensing elements during one or more detection intervals. These detection intervals are synchronized with the carrier frequency of the carrier wave that is used in temporally modulating the illumination beams.

In addition to the temporal modulation of the illumination beams, processing circuitry in the apparatus drives the illumination assembly to apply a spatial modulation pattern to the array of beams. (As noted above, this spatial modulation may be applied, for example, to either the amplitude or the carrier frequency of the beams, or both.) The processing circuitry takes this spatial modulation into account in processing the signals output by the sensing elements in order to generate a depth map of the target scene. In particular, as explained in detail hereinbelow, the processing circuitry makes use of the spatial modulation pattern in estimating the contribution of multipath interference to the signals, and subtracts out this estimated contribution in computing depth coordinates of points in the target scene. The depth coordinates that are obtained in this manner are generally more accurate and consistent and less prone to artifacts than iTOF-based depth coordinates that are computed without the benefit of spatial modulation.

### System Description

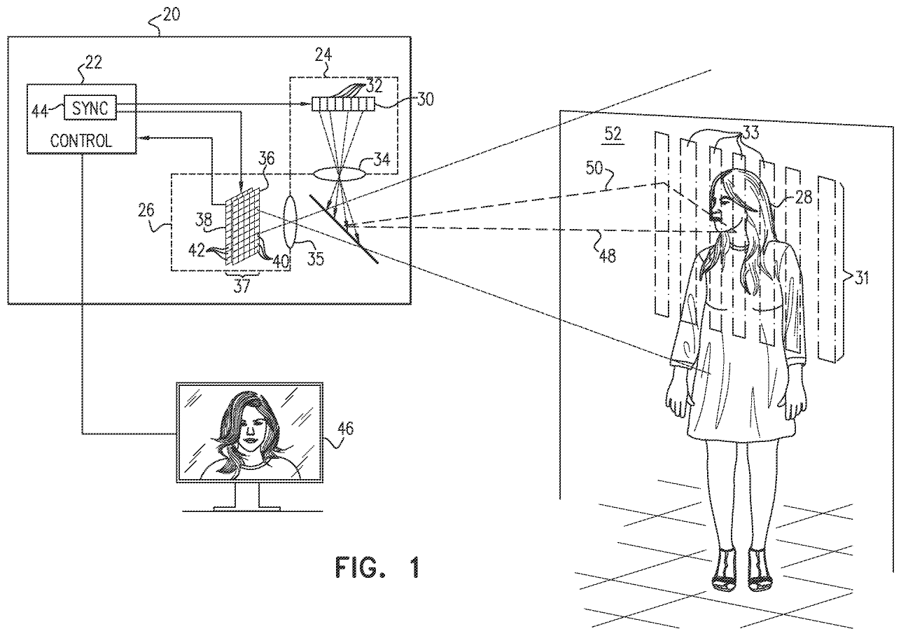

FIG. 1 is a block diagram that schematically illustrates a depth mapping apparatus 20, in accordance with an embodiment of the invention. Apparatus 20 comprises an illumination assembly 24 and a detection assembly 26, under control of processing circuitry 22. In the pictured embodiment, the illumination and detection assemblies are boresighted, and thus share the same optical axis outside apparatus 20, without parallax; but alternatively, other optical configurations may be used. For example, in a non-boresighted configuration, pattern recognition techniques may be used to detect and cancel out the effects of parallax.

Illumination assembly 24 comprises an array 30 of beam sources 32, for example suitable semiconductor emitters, such as semiconductor lasers or light-emitting diodes (LEDs), which emit an array of respective beams of optical radiation toward different, respective points in a target scene 28 (in this case containing a human subject). Typically, beam sources 32 emit infrared radiation, but alternatively, radiation in other parts of the optical spectrum may be used. The emitted beams are temporally modulated with a carrier wave, as described further hereinbelow. The beams are typically collimated by projection optics 34, which in this example comprise one or more refractive elements, such as lenses, but may alternatively or additionally comprise one or more diffractive optical elements (DOEs) or other optical components.

Processing circuitry 22 drives illumination assembly 24 to apply a spatial modulation pattern to array 30 of beam sources, so that the beams form a pattern 31 of stripes 33 extending across the area of interest in scene 28. Alternatively, spatial modulation patterns of different shapes (other than stripes) may be used. In some embodiments, pattern 31 corresponds to a binary amplitude variation, such that during at least some periods of operation of illumination assembly 24, the areas of stripes 33 in the target scene are illuminated by the temporally-modulated beams, while the areas interleaved between the stripes are not illuminated. In one embodiment, processing circuitry 22 drives illumination assembly 24 so that during a first set of periods of operation, stripes 33 are illuminated by the beams while the stripe-shaped areas that are interleaved between stripes 33 are not illuminated by the temporally-modulated beams during this first set of periods. During a second set of periods (for example, alternating with the periods in the first set), the interleaved areas are illuminated while the areas of stripes 33 are not illuminated.

This pattern of spatial modulation is used in compensating for MPI, as explained further hereinbelow. It can also be useful in mitigating other sorts of interference, such as sub-surface scattering, due to light entering a material at one point, scattering inside the medium (and thus traveling a certain distance), and then exiting at another point. This effect occurs, for example, when light is incident on human skin.

A synchronization circuit 44 temporally modulates the amplitudes of the beams that are output by sources 32 with a carrier wave having a certain carrier frequency. For example, the carrier frequency may be 300 MHz, meaning that the carrier wavelength (when applied to the beams output by array 30) is about 1 m, which also determines the effective range of apparatus 20. Typically, the effective range is half the carrier wavelength. Beyond this range, depth measurements may be ambiguous due to range folding. Alternatively, higher or lower carrier frequencies may be used, depending, inter alia, on range and resolution requirements.

In some embodiments, two or more different carrier frequencies may be interleaved spatially, with some beam sources 32 being modulated temporally at one carrier frequency and others at a different carrier frequency. The resulting spatial modulation of carrier frequencies may be used in addition to or instead of the spatial modulation of the beam amplitudes described above. In one embodiment, the beams illuminating stripes 33 are temporally modulated at a one carrier frequency, while the beams illuminating the areas interleaved between the stripes are temporally modulated at a different carrier frequency, for example twice the carrier frequency within the stripes.

In alternative embodiments, illumination assembly 24 may comprise other sorts of beam sources 32 and apply different sorts of modulation patterns to the beams. In one embodiment, array 30 comprises an extended radiation source, whose output is spatially and temporally modulated by a high-speed, pixelated spatial light modulator (SLM) to generate the beams (so that the pixels of the SLM serve as the beam sources). As another example, beam sources 32 may comprise lasers, such as vertical-cavity surface-emitting lasers (VCSELs), which emit short pulses of radiation. In this case, synchronization circuit 44 modulates the beams by controlling the relative times of emission of the pulses by the beam sources.

Detection assembly 26 receives the optical radiation that is reflected from target scene 28 via objective optics 35. The objective optics form an image of the target scene on an array 36 of sensing elements 40, such as photodiodes, in a suitable image sensor 37. Sensing elements 40 are connected to a corresponding array 38 of pixel circuits 42, which demodulate the signal from the optical radiation that is focused onto array 36. Typically, although not necessarily, image sensor 37 comprises a single integrated circuit device, in which sensing elements 40 and pixel circuits 42 are integrated.

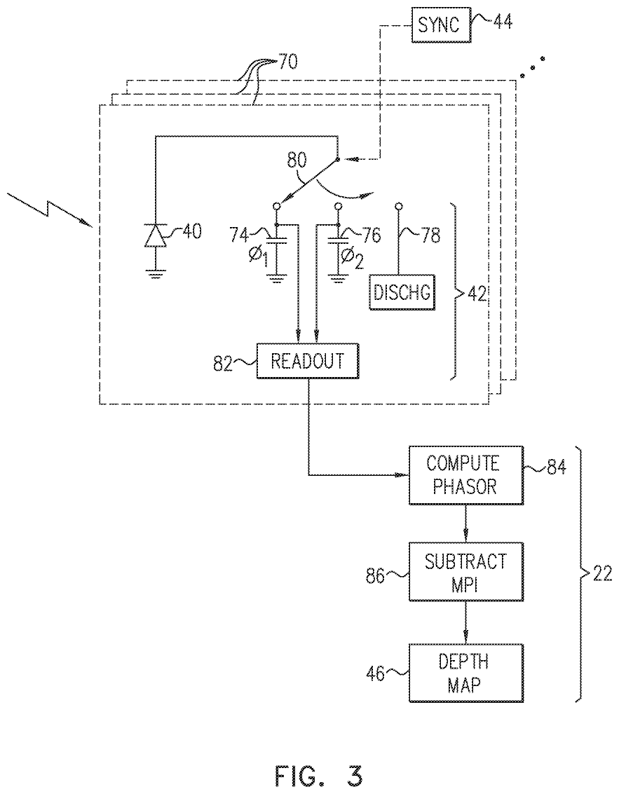

Synchronization circuit 44 controls pixel circuits 42 so that sensing elements 40 output respective signals in response to the optical radiation that is incident on the sensing elements and integrated only during certain detection intervals, which are synchronized with the carrier frequency that is applied to beam sources 32. For example, pixel circuits 42 may apply a suitable electronic shutter to sensing elements 40, in synchronization with the carrier frequency. The detection intervals applied by pixel circuits 42 to sensing elements may be the same over all of the sensing elements in array 36. Alternatively, pixel circuits 42 may comprise switches and charge stores that may be controlled individually to select different detection intervals at different phases relative to the carrier frequency. An embodiment of this sort is shown in FIG. 3.

Objective optics 35 form an image of target scene 28 on array 36 such that each point in the target scene is imaged onto a corresponding sensing element 40. In general, the temporally-modulated illumination that is incident on each point will include two components:
A direct component 48, which impinges on the point along a straight line from illumination assembly; and
A multipath component 50, which impinges on the point after reflection from a surface, such as a wall 52 in the pictured example.
   In general, any given point in the target scene may be illuminated by multiple multipath reflections from different directions. Because multipath components 50 reach points in the target scene along longer paths than direct components 48, the phases of the carrier waves in the multipath components will be different from those in the direct components. When imaged back to detection assembly 26, the multipath components give rise to phase deviations in the signals output by array 36, which can lead to errors in the depth coordinates computed by processing circuitry 22. This phase deviation due to multipath components 50 is referred to herein as multipath interference (MPI).

In the present embodiment, processing circuitry 22 compensates for MPI, and thus reduces the resulting depth errors, using the spatial modulation pattern of stripes 33. In some embodiments, illumination assembly 24 and detection assembly are mutually aligned, and may be pre-calibrated, as well, so that processing circuitry 22 is able to identify the correspondence between the spatial modulation pattern of stripes 33 and sensing elements 40. Alternatively, the alignment may be calibrated empirically by processing the output of detection assembly 26. In either case, processing circuitry 22 can then use the spatial modulation pattern in processing the signals output by the sensing elements, as demodulated by pixel circuits 42, in order to estimate the contribution of MPI to the signals.

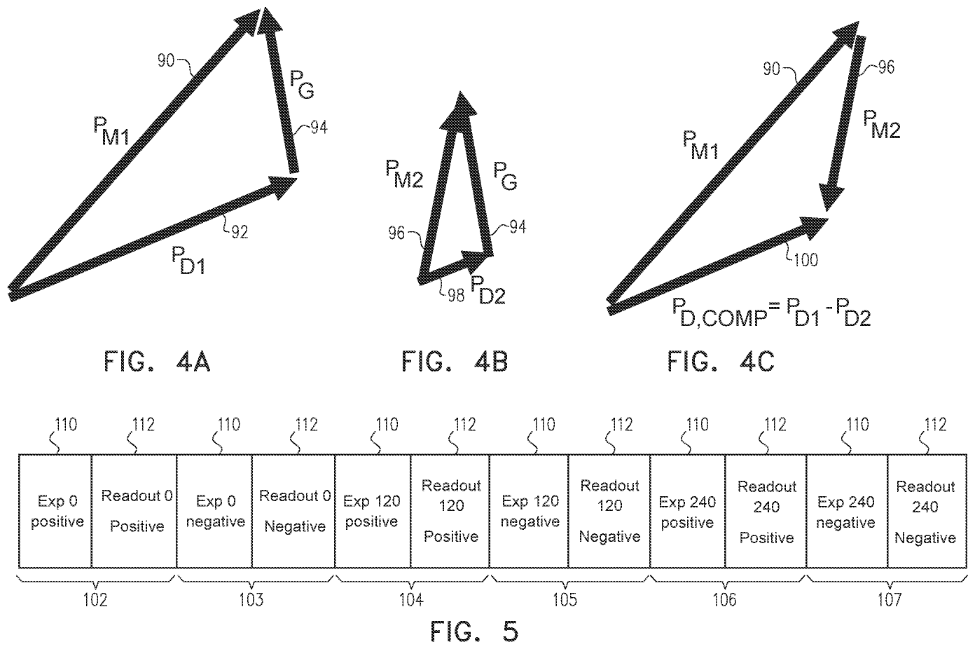

Processing circuitry 22 subtracts out this contribution in computing depth coordinates of the points in the target scene. (The MPI correction may take the form of a phasor computation, as illustrated in FIG. 4, for example.) Processing circuitry 22 may then output a depth map to a display 46 and/or may save the depth map in a memory for further processing.

Processing circuitry 22 typically comprises a general- or special-purpose microprocessor or digital signal processor, which is programmed in software or firmware to carry out the functions that are described herein. The processing circuitry also includes suitable digital and analog peripheral circuits and interfaces, including synchronization circuit 44, for outputting control signals to and receiving inputs from the other elements of apparatus 20. The detailed design of such circuits will be apparent to those skilled in the art of depth mapping devices after reading the present description.

### Illumination Patterns and Processing

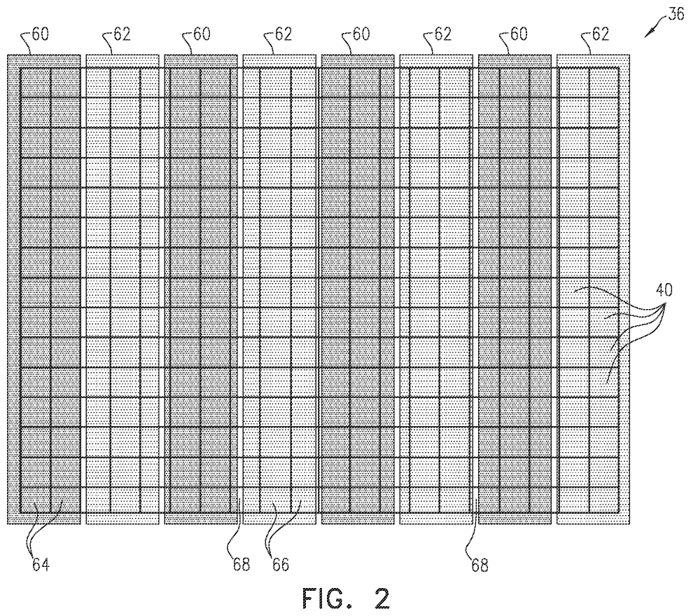

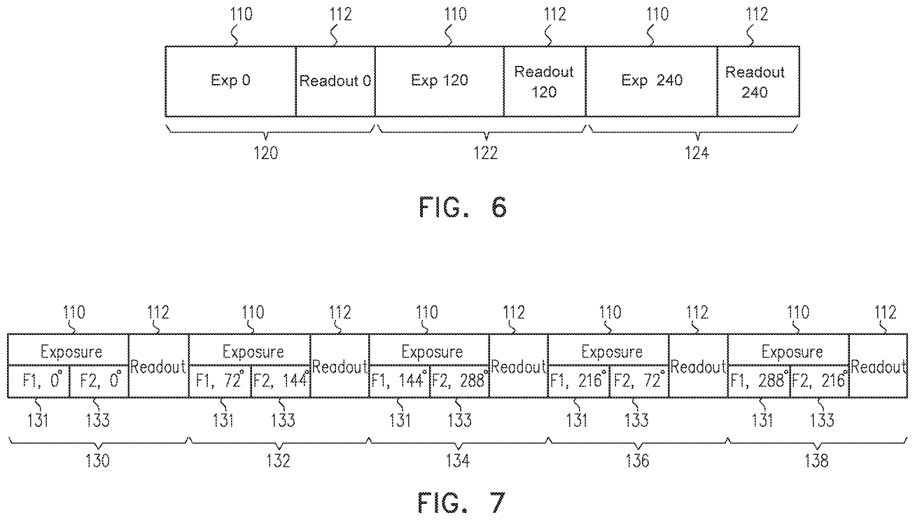

FIG. 2 is a schematic representation of a spatial modulation pattern used in apparatus 20, in accordance with an embodiment of the invention. The pattern, comprising alternating stripes 60, 62, is superimposed on array 36 of sensing elements 40, to represent the manner in which the pattern is imaged onto array 36 by objective optics 35, as in FIG. 1: Illumination module 24 irradiates the target scene with temporally-modulated optical radiation, which is spatially modulated to create a pattern of interleaved sets of stripes 60 and 62. The pattern defines a binary amplitude variation, such that during some periods stripes 60 are illuminated while stripes 62 are not, while during other periods, stripes 62 are illuminated while stripes 60 are not. In an alternative embodiment (as described below with reference to FIG. 6), only stripes 60 are illuminated with the temporally-modulated radiation from illumination module 24, and stripes 62 are not illuminated.

Objective optics 35 image stripes 60 and 62 onto corresponding areas of array 36, as shown in FIG. 2. As a result of this imaging arrangement, direct components 48 of stripes 60 will be imaged onto sensing elements 64 in corresponding columns of array, while direct components 48 of stripes 62 will be imaged onto sensing elements 66. Typically, certain sensing elements 68 will fall in the area of transition between a pair of adjacent stripes 60 and 62 and will thus receive direct components from both stripes.

As long as only stripes 60 are illuminated, the signals output by sensing elements 66 will be due entirely to multipath components 50; and the signals output by sensing elements 64 will be due only to the multipath components of the illumination as long as only stripes 62 are illuminated. MPI generally varies slowly across the area of a target scene, so that neighboring sensing elements will typically experience similar levels of MPI. Therefore, as long as stripes 60 and 62 are narrow relative to the entire field of view of apparatus 20, the amplitude and phase of the multipath contribution to the signal output by a given sensing element 66 due to illumination of stripes 60 will be representative of the multipath contribution to the same sensing element due to stripes 62, and vice versa with respect to sensing elements 64. Processing circuitry 22 can thus estimate the contribution of MPI to the signal output by any given sensing element 64 based either on the signal output by this sensing element under illumination of stripes 62, or even based on the MPI measured for a nearby sensing element 66. The contribution of MPI to the signals output by sensing elements 66 and 68 can be estimated in like fashion. The process of MPI estimation and subtraction is described further hereinbelow with reference to FIGS. 4A-C.

FIG. 3 is a block diagram that schematically shows details of sensing and processing circuits in depth mapping apparatus 20, in accordance with an embodiment of the invention. Image sensor 37 is represented in this figure as an array of pixels 70, each comprising a sensing element 40 and corresponding pixel circuit 42.

Sensing elements 40 in this example comprise photodiodes, which output photocharge to a pair of charge storage capacitors 74 and 76, which serve as sampling bins in pixel circuit 42. A switch 80 is synchronized with the carrier frequency of beam source 30 so as to transfer the photocharge into capacitors 74 and 76 in two different detection intervals at different temporal phases, labeled ϕ1 and ϕ2 in the drawing. As detection intervals at three or more different phases are required for the iTOF depth computation, synchronization circuit 44 may vary the phase of operation of switch 80 so that detection intervals at different phases are collected in successive image frames. Alternatively or additionally, the temporal phase of the carrier wave applied to beam sources 32 may be varied over different image frames. Further alternatively or additionally, different switching phases may be applied concurrently in different, neighboring pixels 70, and the signals from these neighboring pixels may be combined in the depth computation. As yet another alternative, each pixel may comprise only a single charge storage capacitor or even three or more charge storage capacitors. The signals stored in the capacitor or capacitors may be combined over multiple frames and/or multiple pixels as required for the depth computation.

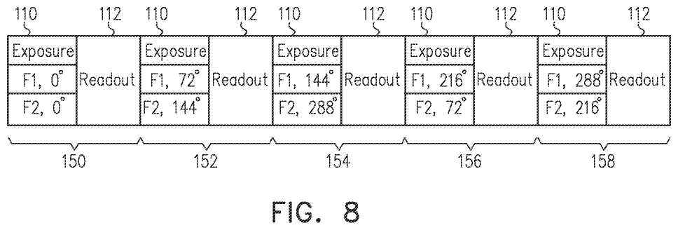

The detection intervals of capacitors 74 and 76 may be equal in duration, meaning that the duty cycle of the detection intervals is 50%. Alternatively, switch 80 may dwell longer on one of capacitors 74 and 76 than on the other, so that the duty cycle is not equal to 50%. This latter arrangement can be advantageous in embodiments in which the carrier frequency of temporal modulation varies spatially over the target scene, as explained further hereinbelow with reference to FIG. 8.

Pixel circuit 42 may optionally comprise a discharge tap 78, for example a ground tap or a tap connecting to a high potential (depending on the sign of the charge carriers that are collected) for discharging sensing element 40, via switch 80, between sampling phases. (The charge carriers and voltage polarities in sensing elements 40 may be either positive or negative.)

A readout circuit 82 in each pixel 70 outputs signals to processing circuitry 22. The signals are proportional to the charge stored in capacitors 74 and 76. Arithmetic logic 84, which may be part of processing circuitry 22 or may be integrated in pixel circuit 42, processes the respective signals from the different phases sampled by pixels 70. Logic 84 combines the signals over multiple frames and/or multiple neighboring pixels in order to compute a phasor, which is indicative of the phase and amplitude of the signals received from a corresponding point in the target scene, relative to the phase of the carrier wave with which the illumination beams are temporally modulated. During this process, logic 84 also optionally computes an offset, which is proportional to the amount of light collected by pixel 70 that is not demodulated. This light includes constant ambient illumination and light from sources with different modulation characteristics from that emitted by beam sources 32.

Logic 84 calculates a function whose inputs are the different phases sampled by pixels 70, and whose outputs are the phasor and offset. For this purpose, for example, logic 84 computes a Fourier transform of the inputs and then extracts the DC and first frequency components from the Fourier transform. Alternatively, the phases sampled by pixels 70 can be fitted to a pre-calibrated waveform, in order to compute the offset, amplitude and phase of the waveform that best match the measured samples. As yet another alternative, machine learning techniques, such as techniques based on neural networks, can be used to learn this function.

For the purpose of MPI compensation, this phasor computation is carried out by arithmetic logic 84 with respect to two different phases of the spatial modulation pattern, as explained above. The term “phases” in the context of the spatial modulation pattern can refer either to spatial phases or temporal phases, depending on the implementation. In the example shown in FIG. 2, each stripe 60, 62 corresponds to a single spatial phase of the spatial modulation pattern, within a period consisting of a pair of adjacent stripes. Alternatively or additionally, the spatial modulation pattern may vary temporally, in which case the signals may be sampled at any given pixel in two different temporal phases of the temporal variation of the spatial modulation pattern.

Thus, in one embodiment, the signals are taken from a single sensing element 40 in different temporal phases of the spatial modulation pattern that are imaged onto the sensing element during different periods of operation of the illumination assembly. For example, one phasor may be computed for each sensing element 40 in a temporal phase in which stripes 60 are illuminated, and a second phasor may be computed in a second temporal phase in which stripes 62 are illuminated. Alternatively, the signals used in the two phasor computations may be from different, neighboring sensing elements 40, for example one sensing element 64 and a neighboring sensing element 66, which are located in different spatial phases of the spatial modulation pattern. In either case, processing circuitry 22 is thus able to derive phasors that are indicative of both the direct and multipath contributions to the optical radiation received in each pixel 70. MPI compensation logic 86 computes a difference between the phasors in order to digitally subtract out the contribution of MPI from the phase of the reflected radiation received from each point in the target scene. Processing circuitry 22 applies this corrected phase in computing the depth coordinates of the points for depth map 46.

FIGS. 4A, 4B and 4C are phasor diagrams that schematically illustrate the process of canceling multipath interference in the depth calculation described above, in accordance with an embodiment of the invention. Processing circuitry 22 computes two phasors 90 (P_{M1}) and 96 (P_{M2}), in two different, respective phases of the spatial modulation pattern, such as the pattern of alternating stripes 60 and 62 that is shown in FIG. 2. Each phasor 90, 96 comprises a respective direct path contribution 92 (P_{D1}) or 98 (P_{D2}), along with a global multipath contribution 94 (P_{G}) which is assumed to be equal for both phases. For sensing elements 64 and 66, which are illuminated entirely by a single, respective stripe 60 or 62, P_{D2} will be zero; but FIG. 4B illustrates the more general case that is encountered in sensing elements 68, which fall in the area of transition between a pair of adjacent stripes, so that both stripes 60 and 62 make a direct contribution.

As shown in FIG. 4C, subtraction of phasor 96 from phasor 90 gives an MPI-compensated phasor 100 (P_{D,COMP}), from which multipath contribution 94 has been canceled out. Although this subtraction is typically carried out digitally by processing circuitry 22, it could alternatively be carried out in the analog domain if one of the two phases of the spatial modulation pattern is also shifted in temporal phase by 180° relative to the other spatial modulation phase. The accuracy of the depth coordinate that is derived from phasor 100 is enhanced by cancellation of the MPI contribution to phasor 90.

This accuracy may be degraded by noise in the signals output by the sensing elements, which will be translated into noise in the measurements of phasors 90 and 96. The subtraction of the phasors may be weighted or otherwise smoothed in order to optimize the balance between MPI cancellation and noise in phasor 100. Because the MPI component has slow spatial variation, spatial smoothing can eliminate the noise almost completely. For example, phasors 90 and 96 can be measured within stripes 60 and 62 (which can be identified simply by comparing the amplitudes of phasors 90 and 96 at different pixels). The areas corresponding to the stripes in the output image are then eroded morphologically in order to exclude the transition regions between stripes. Following this erosion, the values of phasor 96 are spatially filtered to smooth the values and remove noise, as well as filling in the blanks that have been created in the eroded transition regions. Finally, the smoothed phasors 96 are subtracted from original phasors 90 to give phasors 100. These latter phasors 100 may be filtered further if desired.

### Timing Schemes for MPI Cancellation

FIG. 5 is a schematic timing diagram illustrating a scheme for capture and readout of iTOF data, in accordance with an embodiment of the invention. In this embodiment, the spatial modulation pattern has the form shown in FIG. 2, with different, complementary temporal phases of the time-varying spatial modulation pattern being projected onto the target scene during different respective periods of operation of illumination assembly 24. In other words, stripes 60 are illuminated with temporally-modulated radiation in alternation with stripes 62. Illumination of stripes 60 is referred to arbitrarily as the “positive” phase of the pattern, whereas illumination of stripes 62 is referred to as the “negative” phase.

As illustrated in FIG. 5, over a series of image frames 102, 103, 104, . . . , 107 synchronization circuit 44 actuates pixels 70 (FIG. 3) to integrate photocharge during an exposure period 110, and the signals are read out of the pixels during a subsequent readout period 112. In this example, for the sake of simplicity, the photocharge is integrated in three temporal phases relative to the phase of the illumination carrier wave: 0°, 120° and 240°, with each temporal phase captured in a different, respective frame. Furthermore, the spatial modulation pattern itself is modulated temporally, with stripes 60 and 62 being illuminated in alternation.

Thus, the spatial modulation pattern and signal readout follow the following sequence, which covers six frames corresponding to the three different temporal phases of the carrier wave over which signals are integrated, times two different temporal phases of the spatial modulation pattern:
During frame 102, photocharge is captured and read out at 0° while the target scene is illuminated with the positive phase of the pattern (stripes 60).
During frame 103, photocharge is captured and read out at 020 while the target scene is illuminated with the negative phase of the pattern (stripes 62).
During frame 104, photocharge is captured and read out at 120° while the target scene is illuminated with the positive phase of the pattern (stripes 60).
During frame 105, photocharge is captured and read out at 120° while the target scene is illuminated with the negative phase of the pattern (stripes 62).
During frame 106, photocharge is captured and read out at 240° while the target scene is illuminated with the positive phase of the pattern (stripes 60).
During frame 107, photocharge is captured and read out at 240° while the target scene is illuminated with the negative phase of the pattern (stripes 62).

The six measurement results defined above are then used in computing phasors 90 for the positive phase of the spatial modulation pattern and 96 for the negative phase of the spatial modulation pattern. Phasor 90 is computed for each pixel based on the frames during which that pixel is illuminated by the stripe in which it is located, whereas phasor 96 is computed based on the frames during which the pixel is not illuminated. In other words, for pixels 64, phasor 90 is computed based on frames 102, 104 and 106, whereas phasor 96 is computed based on frames 103, 105 and 107. For pixels 66, these relations are reversed.

Alternatively, the different temporal phases of the carrier wave may be read out concurrently from different, successive rows of image sensor 37 and then combined to create larger depth pixels with better temporal resolution. Further alternatively or additionally, larger numbers of phases may be integrated and read out, and in some implementations, multiple phases may be integrated and read out during the same frame, for example using the pixel architecture illustrated in FIG. 3.

FIG. 6 is a schematic timing diagram illustrating a scheme for capture and readout of iTOF data, in accordance with another embodiment of the invention. In this case, a fixed spatial modulation pattern is used, in which stripes are illuminated with temporally-modulated radiation, while stripes 62 are not illuminated. During three successive frames 120, 122 and 124, output signals are collected from both pixels 64 and pixels 66, with respective phases of 0°, 120° and 240° relative to the phase of the illumination carrier wave. In this case, phasor 90, is computed on the basis of the signals read out from pixels 64, while phasor 96 is computed on the basis of the signals read out from nearby pixels 66. Thus, the temporal resolution of this scheme is improved relative to the scheme shown in FIG. 5, at the expense of some degradation in spatial resolution.

FIG. 7 is a schematic timing diagram illustrating a scheme for capture and readout of iTOF data, in accordance with yet another embodiment of the invention. In this case, the spatial modulation pattern defines a spatial variation of the carrier wave frequency, such that the beams illuminating stripes 60 are modulated at a first carrier frequency (F1), while the beams illuminating stripes 62 are modulated at a different, second carrier frequency (F2). At frequency F1, phasor 90, representing the direct path signal contribution (with the addition of MPI), is measured in pixels 64, and phasor 96, representing the multipath signal contribution is measured in pixels 66. At frequency F2, the roles of pixels 64 and 66 are reversed. The signal components at the two frequencies can be separated, for example, by applying a Fourier transform to the output signals, or using any other sort of digital frequency filtering that is known in the art. For both pixels 64 and 66, the respective phasor 96 is calculated from nearby pixels and is subtracted from the respective phasor 90 in order to derive the respective MPI-compensated phasor 100.

For pixels 68 in the transition areas, a weighted combination of the calculated depth at each frequency F1 and F2 may be used to compute the final depth output. Specifically, the signals output by pixels 68 are processed the same way as both pixels 64 (at F1) and pixels 66 (at F2). The phasor at each frequency is converted to a depth, after which a weighted average can be taken. Pixels 64 and 66 can be processed in this way as well, as long as the weights take into account the amplitude measured at each frequency, which would lead to a weight close to zero for frequency F2 at pixels 64 and for frequency F1 at pixels 66. This approach is advantageous in that it does not require any prior knowledge about the spatial modulation pattern or dedicated image processing to differentiate between pixels 64, 66 and 68.

Generally speaking, frequencies F1 and F2 can be chosen arbitrarily. In this case, in order to extract the output signals from pixels 70 at two different carrier frequencies, at least five different integration phases are needed relative to each of the two carrier frequencies F1 and F2. Typically, switch 80 (FIG. 3) is modulated at the same carrier wave frequency as the light incident on the pixel 70. As it is difficult to operate different pixels and 66 at different frequencies F1 and F2 simultaneously, the positive and negative phases of the spatial modulation pattern are time-multiplexed during each exposure 110. During a first part 131 of each exposure, stripes 60 are modulated at frequency F1 and projected onto target scene 28, while switch 80 in all pixels 70 is modulated at the same frequency Fl. Then, during a second part 133, stripes 62 are modulated at frequency F2 and projected onto target scene 28, while switch 80 in all pixels 70 is modulated at the same frequency F2.

Based on this illumination scheme, the data needed to compute the depth coordinate at each pixel are read out over five successive frames:
During a frame 130, photocharge is captured at a phase of 0° relative to the carrier wave at F1 during a first part 131 while the target scene is illuminated with the positive phase of the pattern (stripes 60); and at a phase of 0° relative to the carrier wave at F2 during a second part 133 while the target scene is illuminated with the negative phase of the pattern (stripes 62).
During a frame 132, photocharge is captured at a phase of 72° relative to the carrier wave at F1 during first part 131 while the target scene is illuminated with the positive phase of the pattern (stripes 60); and at a phase of 144° relative to the carrier wave at F2 during second part 133 while the target scene is illuminated with the negative phase of the pattern (stripes 62).
During a frame 134, photocharge is captured at a phase of 144° relative to the carrier wave at F1 during first part 131 while the target scene is illuminated with the positive phase of the pattern (stripes 60); and at a phase of 288° relative to the carrier wave at F2 during second part 133 while the target scene is illuminated with the negative phase of the pattern (stripes 62).
During a frame 136, photocharge is captured at a phase of 216° relative to the carrier wave at F1 during first part 131 while the target scene is illuminated with the positive phase of the pattern (stripes 60); and at a phase of 72° relative to the carrier wave at F2 during second part 133 while the target scene is illuminated with the negative phase of the pattern (stripes 62).
During a frame 138, photocharge is captured at a phase of 288° relative to the carrier wave at F1 during first part 131 while the target scene is illuminated with the positive phase of the pattern (stripes 60); and at a phase of 216° relative to the carrier wave at F2 during second part 133 while the target scene is illuminated with the negative phase of the pattern (stripes 62).

FIG. 8 is a schematic timing diagram illustrating a scheme for capture and readout of iTOF data, in accordance with an alternative embodiment of the invention. As in the preceding embodiment, stripes 60 are modulated at frequency F1, while stripes 62 are modulated at frequency F2, but in this case, the frequencies are chosen so that F2=2*F1. This choice of frequencies is advantageous because the acquisition of the signals at F1 and F2 can occur in parallel within each frame. Thus, assuming F1 to be the lower frequency, the data needed to compute the depth coordinate at each pixel are read out over five successive frames:
During a frame 150, photocharge is captured and read out at a phase of 0° relative to the carrier wave at F1, as well as at F2.
During a frame 152, photocharge is captured and read out at a phase of 72° relative to the carrier wave at F1, which is equivalent to 144° relative to the carrier wave at F2.
During a frame 154, photocharge is captured and read out at a phase of 144° relative to the carrier wave at F1, which is equivalent to 288° relative to the carrier wave at F2.
During a frame 156, photocharge is captured and read out at a phase of 216° relative to the carrier wave at F1, which is equivalent to 72° relative to the carrier wave at F2.
During a frame 158, photocharge is captured and read out at a phase of 288° relative to the carrier wave at F1, which is equivalent to 216° relative to the carrier wave at F2.

In this scheme, however, the signal at frequency F2 will be washed out if the sampling duty cycle of switch 80 (FIG. 3) is set to 50%. To mitigate this problem, the duty cycle for collection of photocharge can be set to a value other than 50%, as explained below.

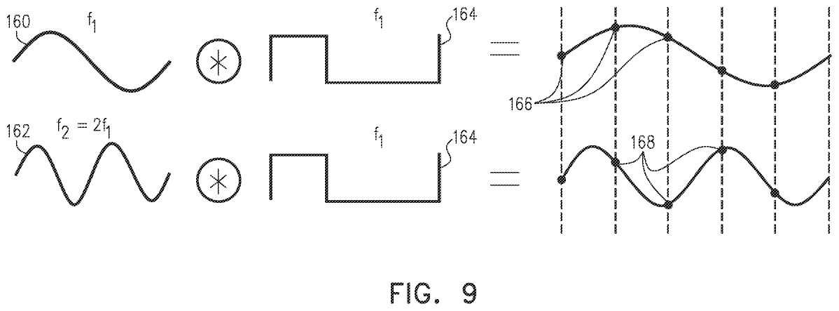

FIG. 9 is a plot that schematically illustrates a method for capture and readout of multi-frequency iTOF data, in accordance with an alternative embodiment of the invention. This embodiment applies different carrier frequencies F1 and F2 to the beams that irradiate different areas of the scene, such as in stripes 60 and 62, as explained above in reference to FIG. 8, with F2=2*F1, as illustrated by carrier waves 160 and 162 in FIG. 9. Synchronization circuit 44 controls switch 80 (FIG. 3) so that capacitors 74 and 76 collect charge during different, respective integration intervals at a sampling frequency equal to F1. Over a sequence of frames, the integration intervals are shifted to different phases relative to the carrier wave, as explained above.

This integration and sampling pattern is illustrated by sampling waveforms 164, in which switch 80 directs photocharge to capacitor 74 while the waveform is high, and then directs the photocharge to capacitor 76 while the waveform is low. As shown by waveform 164, the duty cycle of the sampling periods is not equal to 50%. Rather, photocharge is collected in capacitor 74 for a shorter period than in capacitor 76. The shorter period of collection in capacitor 74 is most useful in sensing the signal at frequency F2 (which would be washed out if the duty cycle were 50%, as noted above), while the longer period of collection in capacitor 76 is useful in improving the signal strength at frequency F1. For these purposes, the duty cycle may advantageously be set, for example, to a value between 30% and 45%. This scheme thus enables efficient, simultaneous collection of data points 166 and 168, representing the signals at both F1 and F2, and requires a smaller number of successive frames (as few as five frames, as shown in FIG. 8) in order to construct phasors 90 and 96 at all pixels, by comparison with schemes in which F1 and F2 are sampled separately.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for optical sensing, comprising:
an illumination assembly, which is configured to direct a first array of beams of optical radiation toward different, respective areas in a target scene while temporally modulating the beams with a carrier wave having a carrier frequency;
a detection assembly, which is configured to receive the optical radiation that is reflected from the target scene, and comprises:
a second array of sensing elements, which are configured to output respective signals in response to the optical radiation that is incident on the sensing elements during one or more detection intervals, which are synchronized with the carrier frequency; and
objective optics, which are configured to form an image of the target scene on the second array; and
processing circuitry, which is configured to drive the illumination assembly to apply a spatial modulation pattern to the first array of beams and to process the signals output by the sensing elements responsively to the spatial modulation pattern in order to generate a depth map of the target scene.

2. The apparatus according to claim 1, wherein the processing circuitry is configured to use the spatial modulation pattern in estimating a contribution of multipath interference to the signals, and to subtract out the contribution in computing depth coordinates of points in the target scene.

3. The apparatus according to claim 2, wherein the processing circuitry is configured to receive, with respect to each of the points, first and second signals output by the array of sensing elements in response, respectively, to first and second phases of the spatial modulation pattern, to compute first and second phasors based on a relation of the first and second signals, respectively, to the carrier wave, and to compute a difference between the first and second phasors in order to subtract out the contribution of the multipath interference.

4. The apparatus according to claim 3, wherein the processing circuitry is configured to derive the first and second signals from different, respective first and second sensing elements in the vicinity of each of the points, wherein different, respective phases of the spatial modulation pattern on the target scene are imaged onto the first and second sensing elements.

5. The apparatus according to claim 3, wherein the processing circuitry is configured to derive the first and second signals from a respective sensing element in the vicinity of each of the points, due to different, first and second phases of the spatial modulation pattern on the target scene that are imaged onto the respective sensing element during respective first and second periods of operation of the illumination assembly.

6. The apparatus according to claim 1, wherein the spatial modulation pattern defines a binary amplitude variation such that during at least some periods of operation of the illumination assembly, first areas of the target scene are illuminated by the temporally-modulated beams, while second areas of the target scene, interleaved between the first areas, are not illuminated by the temporally-modulated beams.

7. The apparatus according to claim 6, wherein the processing circuitry is configured to drive the illumination assembly so that the first areas of the target scene are illuminated by the temporally-modulated beams while the second areas of the target scene are not illuminated by the temporally-modulated beams during first periods of the operation, and the second areas of the target scene are illuminated by the temporally-modulated beams while the first areas of the target scene are not illuminated by the temporally-modulated beams during second periods of the operation.

8. The apparatus according to claim 1, wherein the spatial modulation pattern defines a spatial variation of the carrier wave, such that first beams illuminating respective first areas of the target scene are modulated at a first carrier frequency, while second beams illuminating respective second areas of the target scene are modulated at a second carrier frequency, different from the first carrier frequency.

9. The apparatus according to claim 8, wherein the second carrier frequency is twice the first carrier frequency, and wherein the detection intervals of the sensing elements have a sampling frequency that is equal to the first carrier frequency and a duty cycle that is not equal to 50%.

10. The apparatus according to claim 1, wherein the spatial modulation pattern defines multiple parallel stripes extending across the target scene, including at least a first set of the stripes and a second set of the stripes interleaved in alternation with the first set, having different, respective first and second modulation characteristics.

11. The apparatus according to claim 1, wherein the spatial modulation pattern defines a grid including at least first and second interleaved sets of areas, having different, respective first and second modulation characteristics.

12. A method for optical sensing, comprising:
directing a first array of beams of optical radiation toward different, respective areas in a target scene while temporally modulating the beams with a carrier wave having a carrier frequency;
forming an image of the target scene on a second array of sensing elements, which output respective signals in response to the optical radiation that is reflected from the target scene and is incident on the sensing elements during one or more detection intervals, which are synchronized with the carrier frequency;
driving the illumination assembly to apply a spatial modulation pattern to the first array of beams;
processing the signals output by the sensing elements responsively to the spatial modulation pattern in order to generate a depth map of the target scene.

13. The method according to claim 12, processing the signals comprises estimating a contribution of multipath interference to the signals using the spatial modulation pattern, and subtracting out the contribution in computing depth coordinates of points in the target scene.

14. The method according to claim 13, wherein processing the signals comprises receiving, with respect to each of the points, first and second signals output by the array of sensing elements in response, respectively, to first and second phases of the spatial modulation pattern, and wherein estimating the contribution comprises computing first and second phasors based on a relation of the first and second signals, respectively, to the carrier wave, and computing a difference between the first and second phasors in order to subtract out the contribution of the multipath interference.

15. The method according to claim 14, wherein receiving the first and second signals comprises deriving the first and second signals from different, respective first and second sensing elements in the vicinity of each of the points, wherein different, respective phases of the spatial modulation pattern on the target scene are imaged onto the first and second sensing elements.

16. The method according to claim 14, wherein receiving the first and second signals comprises deriving the first and second signals from a respective sensing element in the vicinity of each of the points, due to different, first and second phases of the spatial modulation pattern on the target scene that are imaged onto the respective sensing element during respective first and second periods of operation of the illumination assembly.

17. The method according to claim 12, wherein the spatial modulation pattern defines a binary amplitude variation such that during at least some periods of operation of the illumination assembly, first areas of the target scene are illuminated by the temporally-modulated beams, while second areas of the target scene, interleaved between the first areas, are not illuminated by the temporally-modulated beams.

18. The method according to claim 12, wherein the spatial modulation pattern defines a spatial variation of the carrier wave, such that first beams illuminating respective first areas of the target scene are modulated at a first carrier frequency, while second beams illuminating respective second areas of the target scene are modulated at a second carrier frequency, different from the first carrier frequency.

19. The method according to claim 12, wherein the spatial modulation pattern defines multiple parallel stripes extending across the target scene, including at least a first set of the stripes and a second set of the stripes interleaved in alternation with the first set, having different, respective first and second modulation characteristics.

20. The method according to claim 12, wherein the spatial modulation pattern defines a grid including at least first and second interleaved sets of areas, having different, respective first and second modulation characteristics.
